(19) United States
(12) Patent Application Publication
(10) Pub. No.: US 2007/0111832 A1
(43) Pub. Date: May 17, 2007

(54) Method for controlling the adjustment of a continuously variable transmission

(75) Inventors: Michael Reuschel, Ottersweier (DE); Andre Teubert, Buhl (DE); Andreas Englisch, Buhl (DE)

Correspondence Address: ALFRED J MANGELS, 4729 CORNELL ROAD, CINCINNATI, OH, 452412433, US

(73) Assignee: LuK Lamellen and Kupplungsbau Beteiligungs KG, Buhl (DE)

(21) Appl. No.: 11/541,454

(22) Filed: Sep. 30, 2006

Related U.S. Application Data
(60) Provisional application No. 60/725,881, filed on Oct. 11, 2005.

(30) Foreign Application Priority Data
Oct. 8, 2005 (DE) 10 2005 048 320.8

(51) Int. Cl. F16H 55/56; F16H 59/00

(52) U.S. Cl. 474/12; 474/8

(57) ABSTRACT

A method for controlling the adjustment of a continuously variable transmission in which pairs of conical disks are adjustable relative to each other so that transmission ratios can be set continuously between first and second shafts on which the respective conical disk pairs are positioned. In respective absolute end positions of the adjustable disks the transmission ratio assumes an extreme value. A control system provides that in a first adjustment range the adjustable disks are always kept within relative end positions that are at least at a defined distance from the absolute end positions. In a second operating state, the adjustment of the adjustable disks is controlled in such a way that the adjustable disks can be moved within a second adjustment range over the entire adjustment distance to the absolute end positions, so that in the second operating state a maximum possible spread of the transmission is utilized.

### BACKGROUND OF THE INVENTION

1. Field of the Invention

The present invention relates to a method for controlling the adjustment of a continuously variable transmission, and to a control system for executing the method.

2. Description of the Related Art

A continuously variable transmission includes an endless belt or an endless torque-transmitting means that runs over a driven and a driving pulley. Each pulley is formed by a pair of coaxial conical disks and includes an axially fixed disk and an axially adjustable disk, wherein the axially adjustable disk is movable in the common axial direction for the conical disk pair, while the axially fixed disk is fixed in the axial direction. The adjustment of the axially adjustable disk is executed, for example, by means of a hydraulically operated servo-unit, the structure and operation of which is known and will not be described further. The adjustment value or the adjustment quantity of the adjustable disks is determined by an associated control device, so that the diameter at which the belt contacts each conical disk pair is changed by the adjustment, and hence the various transmission ratios can be set continuously. For control purposes, the system is provided with a hydraulic circuit that contains a pump for supplying hydraulic fluid under pressure to the servo-units, and is also provided with corresponding pressure-regulating valves. The hydraulic fluid pressure is regulated in such away that sliding or slippage of the endless torque-transmitting means on the conical disk pairs is generally minimized, in order to obtain good power transmission values. The control of the disk position adjustment can include as control values the hydraulic pressure in the system, the adjusting force, a current value, or combinations thereof.

One form of control system for a continuously variable transmission is known from EP 0 258 004 B1, in which a transmission ratio control valve is moved as a function of a transmission ratio change speed signal di/dt. Depending upon the transmission radio change speed signal, a first quantitative signal and a second quantitative signal are produced, wherein the first quantitative signal has a value that indicates a transmission ratio that is smaller than the target transmission ratio, and the second quantitative signal has a value that indicates a transmission ratio that is greater than the first quantitative signal and smaller than the target transmission ratio. The control system also contains a correction device that operates when the acceleration signal appears, to first substitute the target transmission ratio for the first quantitative signal, and, when a certain condition of the first quantitative signal and of the actual transmission ratio is reached, to substitute it for the second quantitative signal. When a certain condition of the second quantitative signal and of the actual transmission ratio is reached, the target transmission ratio is utilized.

When setting the transmission ratio in the known system, the absolute end positions that the adjusting control can reach, and to which it can accordingly bring the endless torque-transmitting means, are adapted, or, alternatively, are specified by the mechanical stop positions. However, the adjustment control is normally only allowed to travel to within a certain distance of that point, for example a distance of 3% of the maximum adjusting range away from the absolute end position. That position is called the relative end position. The result of the fact that the rest of the range is not utilized is a reduction in the allowable spread of the transmission compared to the maximum theoretically possible spread, which can lead in an overdrive condition, for example, to a slight increase in fuel consumption compared to the maximum spread, and in underdrive can be accompanied by reduced start-up dynamics. Unconditional travel to the absolute end positions is not possible nor reasonable, however, since that could result in excess clamping of the endless torque-transmitting means or damage to the endless torque-transmitting means.

Starting from that basis, an object of the present invention is to provide a method of controlling the adjustment regulation that results in dynamic start-up behavior of the transmission and low fuel consumption, without the hidden danger that mechanical damage is occurring to the transmission.

### SUMMARY OF THE INVENTION

The object is achieved with a method for controlling the adjustment of a continuously variable transmission, including in particular a control system for executing the method, and a continuously variable transmission having such a control system.

The method is useful for regulating the adjustment of a continuously variable transmission, in particular a CVT transmission that includes a first conical disk pair positioned on a first shaft and a second conical disk pair positioned on a second shaft, and an endless torque-transmitting means for transmitting rotary motion between the pairs of conical disks. Each of the pairs of conical disks has an axially adjustable disk that is movable in the axial direction of the associated shaft, and an axially fixed disk that is fixed in the axial direction of the associated shaft. The respective conical disk spacings are adjustable in relation to each other in such a way that transmission ratios can be set continuously between the first and the second shafts. In the respective end positions of the axially adjustable disks the transmission ratio assumes an extreme value, including a first and a second operating state. In the first operating state, the adjustment of the axially adjustable disks is controlled in such a way that the axially adjustable disks are moved only within a first adjustment range, and are always kept at least a defined distance away from the absolute end positions, so that they only move between relative end positions for which the adjustment distance is shorter than that to the absolute end positions. The second adjustment range includes the first adjustment range and goes beyond it. In a second operating state, the adjustment of the axially adjustable disks is controlled in such a way that the axially adjustable disks can be moved through the entire possible adjustment distance to the absolute end positions within the second adjustment range, so that in a second operating state a greatest possible spread of the transmission is utilized.

Since the transmission is operated in both operating states, and the second operating state in particular can only be drawn upon in certain selected situations while preferably the control and regulation as a whole is such that in normal operation, i.e., when the specially defined situations are not present, as in the existing art, the adjustment is processed only through the limited adjustment range. It is possible to ensure on the one hand that a maximum spread of the transmission is utilized in the special, defined driving situations, while in other situations the emphasis is on conserving the endless torque-transmitting means. Hence, the invention is based upon the notion of defining certain situations in which the greatest possible spread of the transmission will be used, while in the other situations the transmission is adjusted only within a limited range.

The absolute end positions are mechanical stop positions or adapted end positions. The adaptation of the end positions, which is accomplished in the normal manner using control technology, is done for a maximum underdrive or overdrive condition, and the adaptation is performed either before the transmission is started up, or it can be carried out at any time the maximum spread is to be utilized. To adapt the end positions, the control value, in particular the adjusting force, which can also be controlled, for example, through the electric current strength or the hydraulic pressure, is formed by means of a pilot portion and a regulating portion. The regulating portion is preferably learned or noted by a controller, since it can be used later for starting up in the second operating state.

According to a preferred embodiment, in the second operating state the adjustment control is thus able to move specifically to the underdrive/overdrive limit values learned during the adaptation. However, in order to ensure at the same time that no excessive clamping occurs, the regulating portion of the adjustment control is limited, the regulating portion used during the adaptation phase (current/pressure/force value without the pilot portions) being used for the limiting. Matching this regulating portion during the adaptation phase, an offset value is preferably defined that represents the limit to which the regulating portion can move during the second operating state.

Alternatively, when the relative end position values are reached and the adjustment control is supposed to make an adjustment in the second operating state, an offset value to the regulating value for the relative end position is added via a ramp function. The ramp function value can be determined, for example, by noting the regulating portion from the adaptation phase and defining an offset value on the basis of that regulating portion. As soon as the system is to move away again from the absolute end position, that determined offset value is reduced via a quick ramp.

According to a further preferred embodiment, it is also possible to use exclusively the regulating portion of the adaptation phase, without defining a limitation through an offset value. That regulating portion is, instead, then frozen and no longer changed, as soon as the transmission ratio no longer changes in the end position despite differing from the target transmission ratio. According to another preferred embodiment, the adaptation is carried out again each time as soon as the process is to advance to the second operating state, i.e., an adaptation is carried out at each approach to the end transmission ratios. To that end, the regulating portion is preferably frozen as soon as the transmission ratio is no longer changing, so that unnecessary wear on the endless torque-transmitting means due to mechanical loading is prevented. The fact that the transmission ratio is no longer changing is the indication that the end position has been reached. The fact that the regulating portion is frozen makes it possible to prevent the endless torque-transmitting means from running in or the like. Hence the regulation portion is retained until it is time to leave the end position again.

According to another alternative embodiment, the control value, i.e., the total current, or the total pressure, or the total force, is run to a fixed end value by means of a ramp, if the method is to perform the regulation in the second operating state. Thus, a defined value that is not dependent on the adaptation procedure is chosen to regulate the adjustment movement in the second adjustment range. In addition, attention is not paid to the combination of a pilot portion and a regulating portion, but rather for the second operating state exclusively an overall observation is set for the total control value. That fixed end value remains intact until it is time to leave the end position again.

At the same time, the mechanical stops are preferably changed and adapted in a way that makes chain damage, or damage to the endless torque-transmitting means, unlikely. For example, the mechanical stops can be of softer material and of replaceable design, so that they can be replaced as wear items.

In the control according to the invention, the offset value can be a current offset, a pressure offset, or a force offset, depending upon the control value. If a force offset is chosen, a value of 5 kN, for example, is reasonable. The limitation by the offset, or the limitation of the total control value, is preferably accomplished by not using the adjusting pressure as the system-determining pressure.

When a continuously variable transmission is operated by means of a control method according to the present invention, it is thus first determined whether or not a tolerable movement of the endless torque-transmitting means into the absolute end positions is desired in the current operating state, so that the control method moves on into the second operating state. For example, a criterion for moving on to the second operating state can be a demand by the driver for maximum power or a maximum torque to be transmitted between the pairs of conical disks. At the same time, it is advantageous to set a time limit for the second operating state, so that damage to the system is prevented.

If the system determines that a procedure should move on into the second operating state or has done so, and, for example, the maximum length of time during which the procedure can be in the second operating state has not yet passed, a regulation of the adjustment of the axially movable disks is performed according to one of the principles described, so that despite the motion in the immediate vicinity of the absolute end positions of the adjusting apparatus, mechanical damage, or the like, to the endless torque-transmitting means is almost completely prevented.

### BRIEF DESCRIPTION OF THE DRAWINGS

The structure, operation, and advantages of the present invention will become further apparent upon consideration of the following description, taken in conjunction with the accompanying drawings in which:

FIG. 1 shows a schematic control diagram of an embodiment of a control system in accordance with the present invention, and

FIG. 2 shows plots of the regulating value current, the transmission ratio, and the engine speed.

### DESCRIPTION OF THE PREFERRED EMBODIMENTS

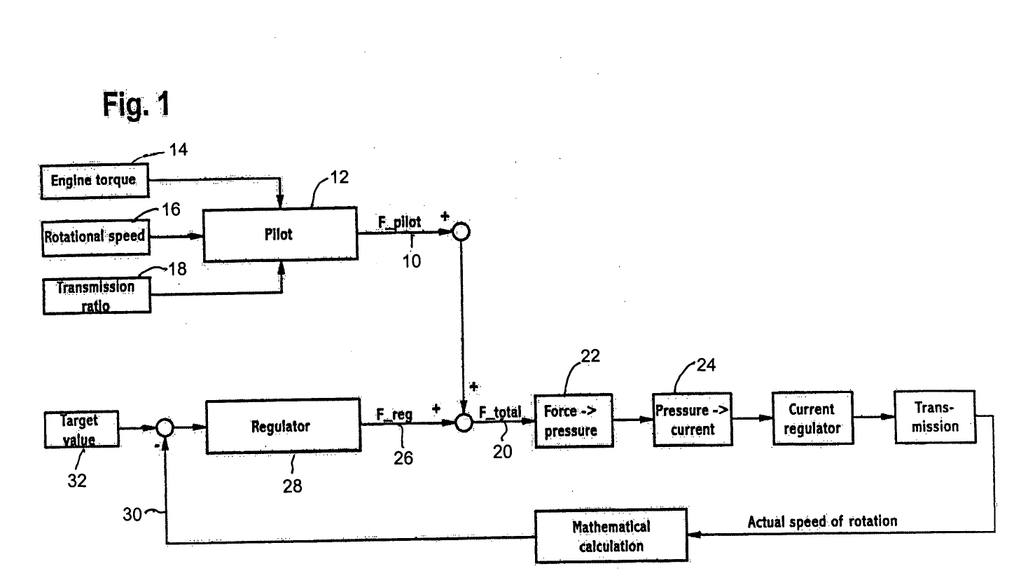

As can be seen from FIG. 1, a pilot force 10, Fₚᵢₗₒₜ, is ascertained by a pilot system 12 on the basis of the engine torque 14, the rotational speed 16, and/or the transmission ratio 18, or other suitable values. The control value, for example a total force 20, a pressure 22, or a current value 24, is ascertained from the pilot force 10, Fₚᵢₗₒₜ, together with a regulating force 26, F_{reg}, which is determined by a regulator 28 on the basis of the actual rotational speed 30 and a target rotational speed 32. In one embodiment of the invention the regulating portion is learned when the end positions are adapted, and can be used subsequently when the system is to move into the zone of the mechanical stops.

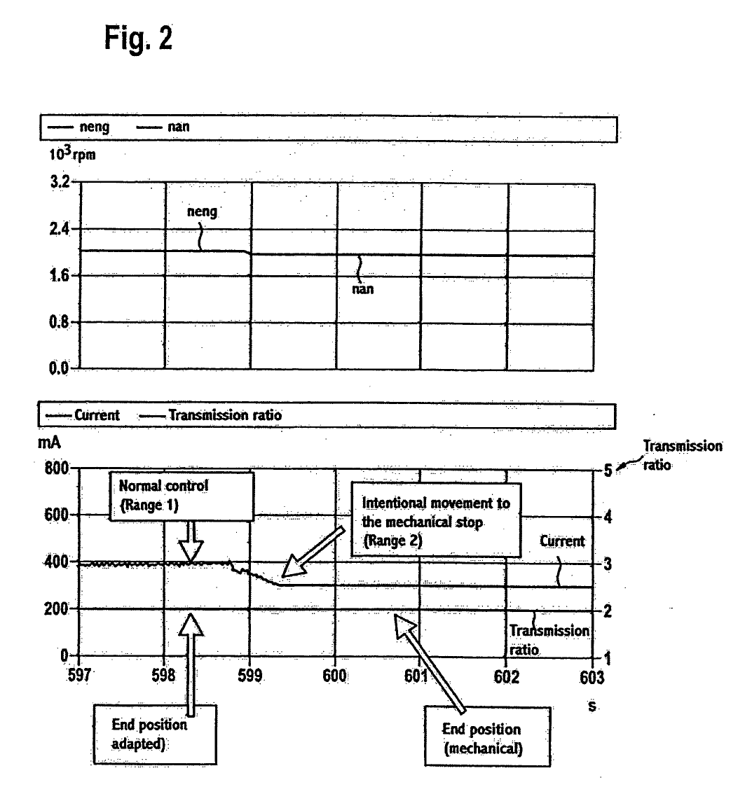

FIG. 2 shows an embodiment where, for a target current value, if the system is leaving the range of normal control and its movement to the mechanical stop is specifically desired, a ramp is defined that adds an offset value to the regulating value for the relative end position. The system then moves from the adapted end position to the mechanical stop position, so that the complete spread of the transmission can be utilized, as can be seen in FIG. 2 on the basis of the transmission ratio and the torque (n_{eng}, nₐₙ).

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A method for controlling the adjustment of a continuously variable transmission having a first pair of conical disks positioned on a first shaft and a second pair of conical disks positioned on a second shaft, an endless torque-transmitting means extending between and contacting the pairs of conical disks for transmitting torque between the conical disk pairs, wherein each of the conical disk pairs has an axially adjustable disk that is movable in the axial direction of its associated shaft and a fixed disk that is axially fixed relative to its associated shaft, and the spacing between disks of the conical disk pairs being adjustable so that transmission ratios between the first and the second shaft can be varied continuously, and wherein when the adjustable disks are in their respective absolute end positions the transmission ratios assume respective extreme values, said method comprising the steps of: controlling the adjustment of the adjustable disks so that in a first operating state the adjustable disks are moved only within a first adjustment range and are maintained at at least a defined distance from the absolute end positions within relative end positions, and controlling the adjustment of the adjustable disks in a second operating state so that the adjustable disks are movable over an entire possible adjustment distance to the absolute end positions within a second adjustment range, so that a greatest possible spread of the transmission is utilized in the second operating state.

2. A method according to claim 1, wherein the absolute end positions are defined by mechanical stops.

3. A method according to claim 1, wherein the absolute end positions are end positions that are adapted for a respective maximum underdrive and maximum overdrive condition, including the step of providing an adjusting force including a pilot portion and a regulating portion to adapt the end positions.

4. A method according to claim 3, including the step of controlling the adjustment of the adjustable disks in the second operating state so that by matching the regulating portion used during the adaptation of the absolute end positions, an offset value is defined within which the regulating portion is set during the second operating state.

5. A method according to claim 3, including the step of defining in the second operating state a regulating portion in the form of a ramp function between the relative end positions and the absolute end positions, wherein the ramp function between the absolute and the relative end positions is defined on the basis of the regulating portion that was used during the adaptation of the absolute end positions.

6. A method according to claim 5, including the step of activating control for the second operating state as soon as the relative end positions are reached.

7. A method according to claim 3, including the step of utilizing a regulating portion in the second operating state for an adjustment that corresponds to the regulating portion for the adjustment during the adaptation of the absolute end positions.

8. A method according to claim 7, including the step of maintaining the regulating portion unchanged as soon as the transmission ratio of the transmission is no longer changing.

9. A method according to claim 3, including the steps of: performing the adaptation of the end positions when the adjustment is operated in the second operating state, and maintaining the regulating portion constant as soon as the translation ratio is no longer changing.

10. A method according to claim 1, including the steps of: determining in the second operating state the total adjusting force by a ramp function between the relative and the absolute end positions, and thereafter maintaining the adjusting force at a maximum force value.

11. A method according to claim 1, including the step of activating the second operating state only when at least one of a power demand from a driver is at a maximum and a torque to be transmitted between the pairs of conical disks is at a maximum.

12. A method according to claim 1, including the step of activating the second operating state only during a limited time period.

13. A method according to claim 1, wherein the adjustment of the adjustable disks is controlled by at least one of regulating the supply of current to an adjusting unit, regulating hydraulic pressure in an adjusting unit, and regulating a force exerted on the adjustable disks.

14. A control system for carrying out the method claimed in claim 1.

15. A continuously variable transmission including a control system according to claim 14.
